(19) United States
(12) Patent Application Publication
(10) Pub. No.: US 2022/0243821 A1
(43) Pub. Date: Aug. 4, 2022

(54) Elastic Seal Arrangement Structure in a Slidingly Fitted Part

(71) Applicant: AISAN KOGYO KABUSHIKI KAISHA, Obu-shi (JP)

(72) Inventors: Akinori ITO, Aichi-ken (JP); Katsuhiko MAKINO, Aichi-ken (JP); Yuji YAMASHITA, Hekinan-shi (JP)

(73) Assignee: AISAN KOGYO KABUSHIKI KAISHA, Obu-shi (JP)

(21) Appl. No.: 17/579,334

(22) Filed: Jan. 19, 2022

(30) Foreign Application Priority Data
Jan. 29, 2021 (JP) 2021-013458

(51) Int. Cl. F16J 15/324; F16J 15/3284

(52) U.S. Cl. CPC F16J 15/324; F16J 15/3284

(57) ABSTRACT

An O-ring arrangement in a slidingly fitted part includes one sliding member (holder), another sliding member (sleeve), a recess, and an O-ring. The O-ring is arranged in the recess in a compressed state to seal the one sliding member and the other sliding member. The area of the sliding contact surface of the O-ring arranged in the recess is coated with a coating to reduce the sliding resistance.

### CROSS-REFERENCE TO RELATED APPLICATIONS

This application claims priority to Japanese patent application serial number 2021-13458 filed Jan. 29, 2021, which is hereby incorporated herein by reference in its entirety for all purposes.

### BACKGROUND

This disclosure relates generally to an elastic seal arrangement in a slidingly fitted part. In particular, this disclosure relates to an O-ring seal arrangement between a shaft-side member and a cylinder-side member. The O-ring seal arrangement is configured to allow relative sliding movement therebetween in the axial direction.

Some types of mechanical devices include a cylinder-side member and a cylindrical shaft-side member that are fitted together. The two members are arranged so that they can slide and move relative to each other in the axial direction. An elastic seal, such as an O-ring, can be positioned between the cylinder-side member and the shaft-side member to reduce the sliding resistance therebetween (e.g., see Japanese Laid-Open Patent Publication No. 2016-56873). In this case, the O-ring usually has a circular cross-sectional shape (i.e., the O-ring is usually a solid torus).

An annular recess is provided on the cylinder-side member or the shaft-side member, and the O-ring is fit within the annular recess in a compressed state. The recess also serves as a grease reservoir for supplying lubricant grease to the sliding parts of the O-ring. In particular, the grease reservoir defined by the recess is filled with grease to lubricate the sliding parts of the O-ring.

### SUMMARY

In accordance with an aspect of the present disclosure, a first embodiment may be an elastic seal arrangement for slidingly fitted parts including a first sliding member having a sliding surface and a second sliding member having a sliding surface in sliding contact with the sliding surface of the first sliding member. The elastic seal arrangement may also comprise a recess and an elastic seal seated in the recess. The recess may be formed on the sliding surface of the first sliding member or the second sliding member. The elastic seal may be seated in the recess in a compressed state to seal between the first sliding member and the second sliding member. A coating, which reduces the sliding resistance, is applied to at least one of the sliding contact surface of the elastic seal and the area of the sliding contact surface of the sliding member in sliding contact with the elastic seal or the other sliding member in sliding contact with the elastic seal.

According to the first embodiment, the coating, which reduces the sliding resistance, is applied to at least one of the sliding contact surface of the elastic seal arranged in the recess and the sliding contact surface of the sliding member in sliding contact with the elastic seal or the other sliding member in sliding contact with the elastic seal. Consequently, the sliding resistance of the elastic seal at each position in the longitudinal direction may be reduced. Therefore, a twisting phenomenon of the elastic seal at each position may be suppressed and/or prevented. As a result, breakage and/or deformation of the elastic seal may be suppressed and/or prevented, thereby maintaining the sealing function of the elastic seal.

In accordance with another aspect of the present disclosure, a second embodiment may be an elastic seal arrangement for the slidingly fitted parts of the first embodiment described above, wherein the first sliding member is a cylinder-side member having a cylindrical shape, and the second sliding member is a shaft-side member having a shaft-shape fitted into the cylinder-side member. The cylinder-side member and the shaft-side member may be arranged to allow relative sliding movement therebetween in the axial direction. The elastic seal fitted in the recess may be an O-ring having an annular shape. The coating, which reduces the sliding resistance, may be applied to the sliding contact surface of the O-ring.

According to the second embodiment, the elastic seal may be the O-ring having a circular cross-sectional shape. The coating, which reduces the sliding resistance, may be applied to the sliding contact surface of the O-ring. Accordingly, a similar effect as in the first embodiment described above may be achieved, even if the elastic seal is an O-ring. As a result, the sealing function by the O-ring may be improved.

In accordance with another aspect of the present disclosure, a third embodiment may be an elastic seal arrangement in the slidingly fitted part of the second embodiment described above, wherein a projection is formed on the outer peripheral surface of the O-ring. The projection extends in the radial direction toward the sliding member with which the O-ring is in sliding contact. The projection may project from within the coating area of the O-ring and may extend outside the sliding contact area of the sliding member with which the O-ring is in sliding contact.

According to the third embodiment, the projection, which is formed on the O-ring, may be formed within the coating area of the O-ring and outside the sliding contact area of the sliding member with which the O-ring is in sliding contact. There was previously a concern that the O-ring may rotate due to the sliding contact of the O-ring. In particular, there is a concern that a portion of the surface where the coating is not applied to the O-ring will be the sliding surface. However, according to the third embodiment, rotation of the O-ring may be suppressed and/or prevented because the projection contacts the sliding member with which the O-ring is in sliding contact, and/or the recess. Therefore, the surface with the coating on the O-ring is always the sliding surface.

In accordance with another aspect of the present disclosure, a fourth embodiment may be an elastic seal arrangement in the slidingly fitted part of the third embodiment described above, wherein the projection may be formed over the circumference of the O-ring. The length of the projection may be at least longer than the thickness of the coating applied to the O-ring.

According to the fourth embodiment, the length of the projection formed on the O-ring may be longer than the thickness of the coating applied to the O-ring. Therefore, it is possible to prevent the coating from scattering to the sliding contact surface of the O-ring in the projection when the coating is applied to the sliding surface of the O-ring.

A fifth embodiment may be an elastic seal arrangement in the slidingly fitted part of the fourth embodiment described above, wherein the length of the projection on the O-ring may be set to the length that the O-ring contacts the sliding member.

According to the fifth embodiment, the length of the projection on the O-ring may be set to the length that the O-ring contacts the sliding member. Therefore, it is possible to appropriately suppress the O-ring from rotating. Additionally, foreign materials may be prevented from entering from behind the sliding direction of the projection.

A sixth embodiment is an elastic seal arrangement in the slidingly fitted part of the third to the fifth embodiment described above, wherein, due to the arrangement of the projection, a space may be defined by the projection, the outer peripheral surface of the O-ring, and the cylindrical surface of the sliding member with which the O-ring is in sliding contact. The space may serve as a second grease reservoir. The volume of the second grease reservoir may be the volume of the space determined by setting the inclination angle of the projection. The inclination angle of the projection may be determined so that the volume of the second grease reservoir is larger than a predetermined volume.

According to the sixth embodiment, the second grease reservoir may be newly formed by the projection. Accordingly, lubricant may be supplied to the sliding portion of the O-ring from two grease reservoirs, that is, a conventional grease reservoir and the second grease reservoir. Therefore, the sliding property of the O-ring may be maintained for a longer period of time.

According to the sixth embodiment, the volume of the second grease reservoir may be greater than the predetermined volume. As a result, lubrication to the sliding contact portion of the O-ring may be sufficient, and the lubrication may be reliably performed.

According to the elastic seal arrangement in the slidingly fitted part disclosed herein, even if the state of compression of the elastic seal in the recess is not in the longitudinal direction, the torsion of the elastic seal in the rotational direction during sliding of the elastic seal may be reduced. As a result, the breakage and/or deformation of the elastic seal may be suppressed and/or prevented, thereby maintaining the sealing function of the elastic seal.

### BRIEF DESCRIPTION OF THE DRAWINGS

For a detailed description of various exemplary embodiments, reference will now be made to the accompanying drawings in which:

FIG. 1 is a cross-sectional view of a purge pump.

FIG. 2 is an enlarged, cross-sectional schematic view of section II of the purge pump of FIG. 1 illustrating the O-ring seal arrangement of FIG. 1 of the slidingly fitted part of the purge pump.

FIG. 3 is an enlarged, cross-sectional schematic view of the O-ring seal arrangement of the slidingly fitted part of the purge pump of FIGS. 1 and 2.

FIG. 4 is an enlarged, cross-sectional view of the section IV of FIG. 3 illustrating the O-ring fitted in the recess.

FIG. 5 is an enlarged, cross-sectional schematic view of an embodiment of an O-ring seal arrangement that can be used for the O-ring seal arrangement of FIG. 3 with the O-ring in an uncompressed state and a coating applied to a sliding surface of the O-ring.

FIG. 6 is an enlarged, cross-sectional schematic view of the O-ring seal arrangement of FIG. 5 with the O-ring in a compressed state.

FIG. 7 is an enlarged, cross-sectional schematic view of an embodiment of an O-ring seal arrangement that can be used for the O-ring seal arrangement of FIG. 3 with the O-ring in an uncompressed state and a coating applied to the sliding surface of the sleeve.

FIG. 8 is an enlarged, cross-sectional schematic view of the O-ring seal arrangement of FIG. 7 with the O-ring in a compressed state.

FIG. 9 is a cross-sectional view of an embodiment of an O-ring that can be used in embodiments of O-ring seal arrangements disclosed herein with a coating applied to the radially outer periphery of the O-ring.

FIG. 10 is a cross-sectional view of the O-ring of FIG. 9 taken along section X-X of FIG. 9.

FIG. 11 is an enlarged, cross-sectional view of the O-ring of FIG. 10 illustrating the location where the projection is formed on the outer surface of the O-ring.

FIG. 12 is an enlarged, cross-sectional view of an embodiment of an O-ring seal arrangement including the O-ring of FIG. 9 fitted in the recess of the holder and grease disposed in the recess and between the O-ring and the sleeve.

FIG. 13 is an enlarged, partial cross-sectional view of the O-ring seal arrangement of FIG. 12 illustrating the second grease reservoir formed by the projection of the O-ring.

FIG. 14 is a schematic view of a packing as another embodiment of an elastic seal.

### DETAILED DESCRIPTION

When an O-ring is fitted in a recess in a compressed state, it is difficult to compress the O-ring evenly due to manufacturing variances in the geometry of the recess, the circular shape of the O-ring, etc. If the O-ring is not compressed evenly, friction arising between the O-ring and the surrounding structure(s) contacting the O-ring may vary at different portions along the outer surface of the O-ring. Consequently, during sliding contact, differences in sliding resistances may occur at various positions along the outer surface of the O-ring. An unevenly compressed O-ring may also result in differences in the torsion of the O-ring in the rotational direction. In some cases, the O-ring may break and/or deform, potentially resulting in the O-ring being unable to sufficiently seal the intended area.

Accordingly, an objective of the present disclosure is to improve the sealing performance of an elastic seal arrangement in a slidingly fitted part. Specifically, an objective of the present disclosure is to reduce the torsion of the elastic seal in the rotational direction during sliding of the elastic seal, even if the elastic seal is not compressed evenly when the elastic seal is fitted in a recess. Accordingly, the sealing performance of the elastic seal may be maintained, for instance by suppressing and/or preventing breakage and/or deformation of the elastic seal.

In order to achieve the above objectives, embodiments of elastic seal arrangements disclosed herein may take the following configurations.

Hereinafter, embodiments of the present disclosure will be described with reference to the figures. The elastic seal is an O-ring in embodiments disclosed herein. Unless otherwise specified, directional indications, such as left and right, up and down, etc., in the description herein refer to the directions in the corresponding illustration.

First, a purge pump 10 will be described as an example of a device in which embodiments of O-ring seal arrangements for slidingly fitted parts disclosed herein can be used. The purge pump 10 may be a fluid pump provided within a fuel vapor treatment device. The fuel vapor treatment device may supply fuel vapor from the fuel tank of a vehicle, such as an automobile, to the intake passage of an internal combustion engine for treatment. The purge pump 10 may be provided between a canister that adsorbs the fuel vapor from the fuel tank and an intake passage of the internal combustion engine.

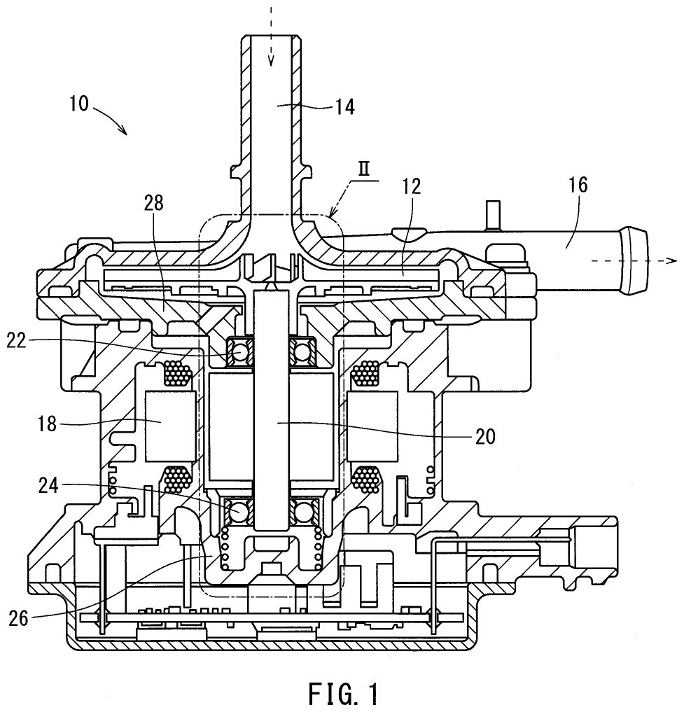

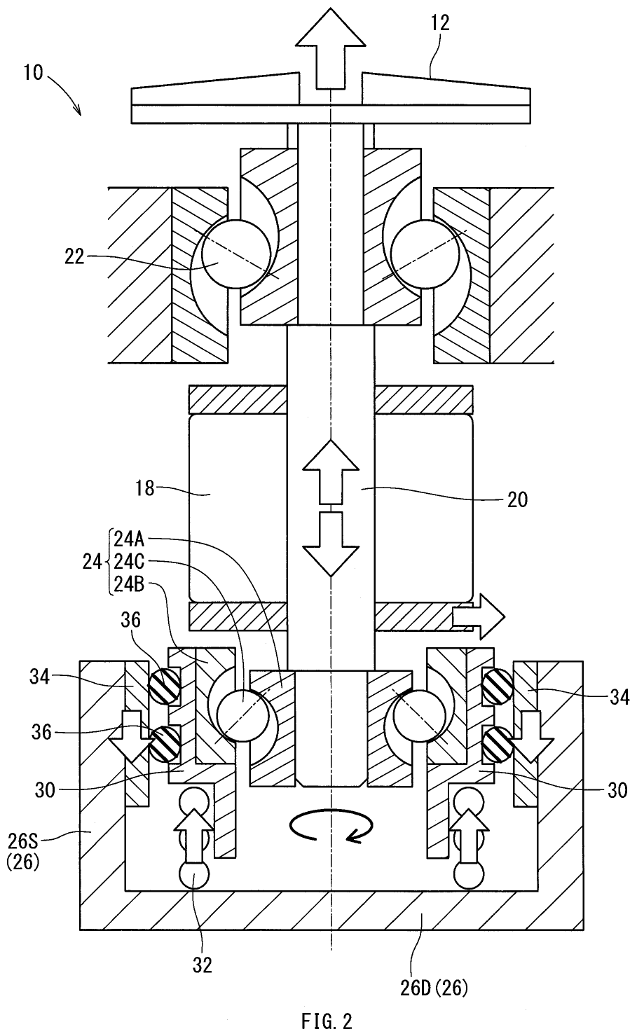

FIG. 1 is a cross-sectional view of the purge pump 10. FIG. 2 is an enlarged, cross-sectional schematic view of section II of FIG. 1. In particular, FIG. 2 illustrates an O-ring seal arrangement of the slidingly fitted part of the purge pump 10. The function of the purge pump 10 will be explained with reference to FIG. 1. In the purge pump 10, fuel vapor from a fuel tank (not shown) may be drawn in via an inlet port 14 due to the rotation of an impeller 12. The fuel vapor may be discharged via a discharge port 16, then supplied to an intake passage of an internal combustion engine (not shown).

The impeller 12 is rotated by an electric motor 18. The rotation of the electric motor 18 is transmitted to the impeller 12 via a rotor shaft 20. Axially spaced ball bearings 22, 24 are located above and below the electric motor 18. The ball bearings 22, 24 rotatably support the rotor shaft 20 relative to a case 26 and a flange 28. The ball bearing 24 at the lower position of the rotor shaft 20 is radially supported with respect to the case 26 by the O-ring seal arrangement in the slidingly fitted portion of the present embodiment.

According to the schematic diagram of the purge pump 10 shown in FIG. 2, the basic structure of the O-ring seal arrangement in the slidingly fitted part of the purge pump 10 will now be described. The directions indicated by the white arrows in FIG. 2 show the directions in which each member of the purge pump 10 extends due to temperature changes. The ball bearing 24, which is located at the lower position of the rotor shaft 20, includes an inner ring 24A, an outer ring 24B, and a ball 24C positioned between inner ring 24A and outer ring 24B. The outer ring 24B is fixably coupled to a holder 30 with the holder 30 structured to cover the outer ring 24B. A coil spring 32 is positioned between the holder 30 and a lower part 26D of the case 26. The coil spring 32 presses the holder 30 and the outer ring 24B upward in the axial direction.

A side part 26S of the case 26 is positioned outward of the ball bearing 24 in the radial direction. The side part 26S has a cylindrical shape. A sleeve 34, which also has a cylindrical shape, is disposed along the inner cylindrical surface of the side part 26S and is fixably coupled thereto. An O-ring 36 is disposed between the sleeve 34 and the holder 30. In the present embodiment, two O-rings 36 are disposed between the sleeve 34 and the holder 30, and spaced apart in the up-down direction.

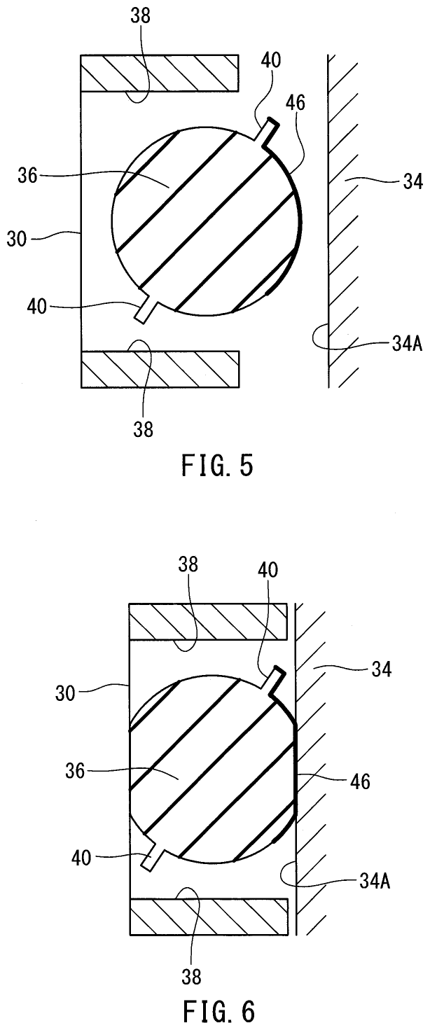

According to the above configuration, the sleeve 34 and the holder 30, with the O-rings 36 disposed therebetween, can move relative to each other in the axial direction (up and down in FIG. 2). For example, the relative movement may be provided to accommodate differences in the linear expansion coefficients of the resin, metal, and other components of the purge pump 10, temperature changes, and other factors. The relative movement may also allow the O-ring 36 to slide to maintain the preload from the coil spring 32 at a constant level. As a result, the rotor shaft 20 may be aligned and shaft runout of the rotor shaft 20 may be suppressed. As described in more detail below, a coating may be applied to the sliding portion of the O-ring 36 (see FIGS. 5-8) and to a projection 40 formed on the O-ring 36 (see FIGS. 5 and 8).

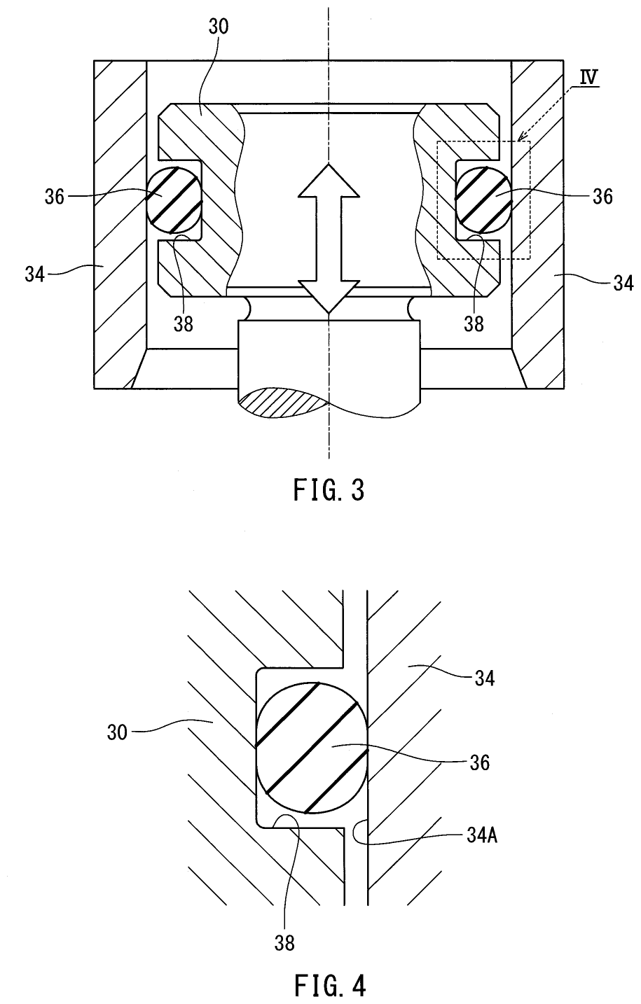

FIG. 3 is a simplified, cross-sectional view of the basic structure of the O-ring seal arrangement of the slidingly fitted part of the purge pump 10 shown in FIGS. 1 and 2. As shown in FIG. 3, the sleeve 34 has a cylindrical shape. The holder 30 also has a cylindrical shape and is fitted within the sleeve 34 to allow relative movement in the axial direction (in the direction of the arrows of FIG. 3) therebetween. The sleeve 34 of the present embodiment may also be referred to as a “sliding member,” “one sliding member,” or “first sliding member” in the present disclosure, and the holder 30 of the present embodiment may also be referred to as a “sliding member,” “another sliding member,” or “second sliding member” in the present disclosure.

An annular recess 38 is provided on the outer peripheral surface of the holder 30. The O-ring 36 is seated in the recess 38 in a compressed state between the sleeve 34 and the holder 30. The O-ring 36, which is fitted in the recess 38, also has an annular shape in its free (uncompressed) state, and is sized to fit in the recess 38. Therefore, the sleeve 34 of the present embodiment may also be referred to herein as a “cylinder-side member” in the present disclosure, and the holder 30 of the present embodiment may also be referred to herein as a “shaft-side member” in the present disclosure. In this embodiment, the sliding member in which the recess 38 is formed is the holder 30.

FIG. 4 is an enlarged, cross-sectional view of section IV of FIG. 3, which illustrates the O-ring 36 in the recess 38. As shown in FIG. 4, the O-ring 36 is seated in the recess 38, which in this embodiment is formed on the holder 30, and further, is compressed between the holder 30 and the sleeve 34 in the radial direction. Therefore, the radially outer peripheral surface of the O-ring 36 is in pressure contact with a cylindrical radially inner peripheral surface 34A of the sleeve 34. In the pressure contacted state, the pressure contact area of the O-ring 36 may slide and move due to the relative movement between the sleeve 34 and the holder 30 in the axial direction (in the direction of the arrows in FIG. 3). In some conventional O-ring seal arrangements, a twisting phenomenon of the O-ring may occur during such sliding, which may cause the whole O-ring to be twisted in the circumferential direction due to the difference in the degree of twisting in the circumferential direction. Such twisting may degrade the sealing function of the O-ring. In FIGS. 3 and 4, a coating 46, which is applied to the sliding portion of the O-ring 36 (see FIGS. 5-8) and/or to a projection 40 formed on the O-ring 36 (see FIGS. 5-8) is omitted for purposes of clarity.

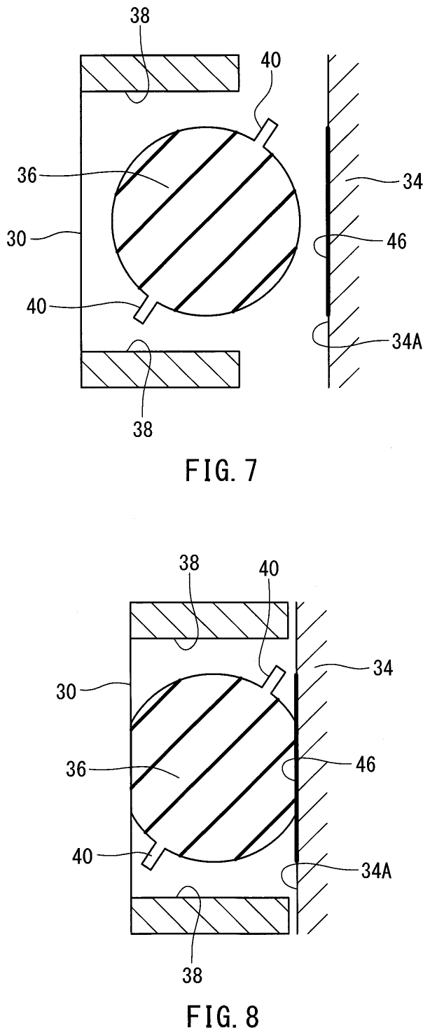

FIGS. 5-8 are enlarged, cross-sectional schematic views illustrating a configuration in which a coating 46 is applied to the O-ring 36 so that the O-ring 36 and the projection 40, which is formed on the O-ring 36, may more easily slide. FIGS. 5 and 6 show a configuration in which the coating 46 is applied to a sliding surface of the O-ring 36. FIGS. 7 and 8 show a configuration in which the coating 46 is applied to the sliding surface of the holder 30. In addition, FIGS. 5 and 7 show the O-ring 36 is in an uncompressed (free) state, whereas FIGS. 6 and 8 show the O-ring 36 is in a compressed state.

The application of the coating 46 to the sliding surface of the O-ring 36 will now be described with reference to FIGS. 5 and 6. As shown in FIG. 6, the coating 46 may be applied to the outer surface of the O-ring 36 that is configured to be in sliding contact with the sliding surface of the sleeve 34. Specifically, the coating 46 may be applied to an area slightly larger than the contact area shown in FIG. 6, so as to account for any slight twisting of the O-ring 36 during sliding.

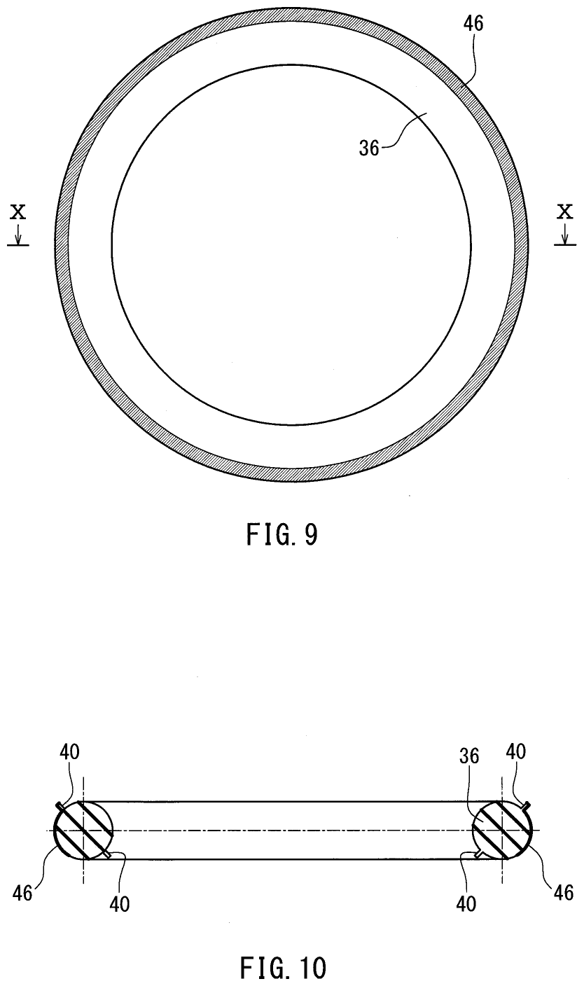

FIGS. 9 and 10 illustrate the O-ring 36 on which the coating 46 has been applied. FIG. 10 is a cross-sectional view taken along section X-X of FIG. 9. As shown in FIG. 9, the coating 46 is applied to the radially outer peripheral surface of the O-ring 36. The projection 40, which will be described later, is omitted in FIG. 9 to more clearly show the area where the coating 46 has been applied.

In the present embodiment, the coating 46 is not applied to the radially inner peripheral surface of the O-ring 36. However, in some embodiments, a different coating may be applied to the radially inner peripheral surface of the O-ring 36, so as to provide a difference in the sliding resistance as compared to the outer peripheral surface.

As described above, by applying the coating 46 to the sliding contact surface of the O-ring 36, the sliding resistance of the sliding contact surface may be reduced. As a result, the sliding movement of the sleeve 34 and the holder 30 relative to each other may be made smooth. When the coating 46 is not applied to the radially inner peripheral surface of the O-ring 36 or when some alternative coating is applied to the radially inner peripheral surface, radially the inner peripheral surface of the O-ring 36 may be a non-sliding contact surface. Consequently, the coefficient of friction at the radially inner peripheral surface may remain relatively high. As a result, it may be possible to effectively suppress the twisting of the O-ring 36 that could occur when the radially outer peripheral surface of the O-ring 36 slides.

FIGS. 7 and 8 illustrate a configuration in which the coating 46 is applied to the sliding surface of the sleeve 34. As shown in FIG. 8, the coating 46 may be applied to the sliding surface of the sleeve 34 in an area where the sleeve 34 contacts the O-ring 36. As in the case of the application of the coating 46 to the O-ring 36 described above, the coating 46 may be applied to the sleeve 34 along an area slightly larger than the contact area shown in FIG. 8 to account for slight twisting of the O-ring 36 during sliding.

As described above, the coating 46 is applied to either the sliding surface of the O-ring 36 as shown in FIGS. 5 and 6, or the sliding surface of the sleeve 34 as shown in FIGS. 7 and 8. However, if necessary, such as to further reduce the sliding resistance, the coating 46 may be applied to the sliding surfaces of both the O-ring 36 and the sleeve 34.

A fluorine coating agent is used as the coating 46 in the present embodiment. Other materials for the coating may be, for example, a diamond coating. The coating 46 used in the present embodiment is preferably made of a material having good slidability and slipperiness. The thickness of the coating 46 of the present embodiment may be, for example, 10 to 50 μm. It is preferable to apply the coating thinly since the coating tends to peel off if the coating is too thick. However, if the coating is made too thin, it may be worn out due to sliding friction. Therefore, the thickness is to be decided based on the results of various experiments, taking these factors into consideration. As a result, the thickness of the coating is set to 20 μm in the present embodiment. The above materials and thickness of the coating are the same for application to the O-rings 36, shown in FIGS. 5 and 6, and to the sleeve 34, shown in FIGS. 7 and 8.

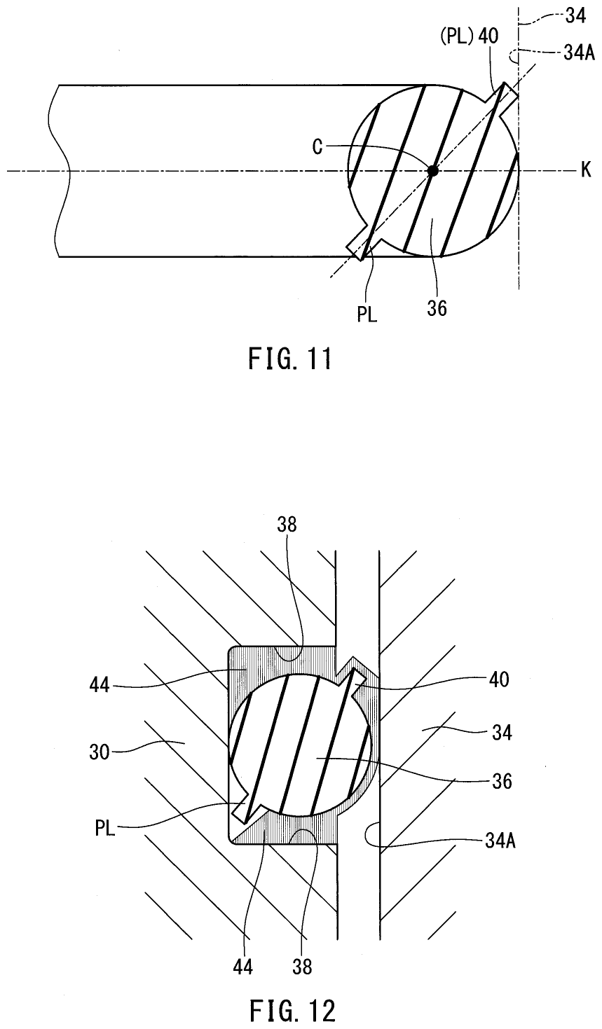

The projection 40, which is formed on the O-ring 36, will now be described. As shown in FIG. 11, the projection 40 is provided on the outer peripheral surface of the O-ring 36. The projecting 40 may be formed so as to be located away from the contact position between the O-ring 36 and the sleeve 34 and inclined toward the cylindrical inner peripheral surface 34A of the sleeve 34. Specifically, the projection 40 is oriented at an incline angle relative to a line K oriented perpendicular to the cylindrical inner peripheral surface 34A of the sleeve 34, as shown in FIG. 11. More specifically, the perpendicular line K is a line extending through the center C of the O-ring 36 and oriented perpendicular to the cylindrical inner peripheral surface 34A of the sleeve 34. The perpendicular line K may intersect the center C of the O-ring 36 on opposite side of the O-ring 36. For purposes of clarity, the coating 46 is omitted in FIG. 11.

The projection 40 of the present embodiment may be formed using the parting line PL (flash) that is formed when the O-ring 36 is molded. For this reason, two projections 40 may be formed at symmetrically opposed positions on the circular cross section of the O-ring 36, i.e., 180 degrees apart. The projections 40 of the present embodiment may be formed in an inclined manner. In the present embodiment, the projection 40 that is formed on the sleeve 34 side is substantially functional. The projection located in the recess 38 of the holder 30 may be formed when forming the parting line PL. However, when the O-ring 36 experiences a twisting phenomenon during sliding, the projection may come into contact with the inner walls of the recess 38 (the bottom surface and the side surface). Thus, the projection extending into the recess 38 may function to suppress the twisting of the O-ring 36.

In the present embodiment, the length of the projection 40 is sufficient to allow the projection 40 to contact the cylindrical inner peripheral surface 34A of the sleeve 34 when the O-ring 36 is compressed in the recess 38. FIG. 6 shows another example in which the length of the projection 40 is insufficient to allow the projection 40 to contact the cylindrical inner peripheral surface 34A of the sleeve 34 when the O-ring 36 is compressed. In other words, as shown in FIG. 6, the length of the projection 40 does not necessarily have to be long enough to contact the cylindrical inner peripheral surface 34A of the sleeve 34 in the compressed state. It may be sufficient that the projection 40 has the length that allows it to contact the cylindrical inner peripheral surface 34A of the sleeve 34 when the O-ring 36 experiences twisting during sliding.

In the present embodiment, the length of the projection 40 may be longer than the thickness of the coating 46. The projection 40 may be arranged within the coating area of the coating 46 on the O-ring 36. The projection 40 may also be arranged outside the sliding contact area on the sleeve 34 of the member with which the O-ring 36 slides and contacts.

As shown in FIG. 12, a grease reservoir may be formed in the recess 38 of the holder 30 in which the O-ring 36 is arranged. Grease 44 may be stored in the grease reservoir. The grease 44 may lubricate the sliding between the O-ring 36 and the sleeve 34.

FIG. 12 shows the storage state where the grease 44 is sealed into the recess 38, which is the grease reservoir, when the O-ring 36 is arranged in the recess 38. Because the grease 44 is stored in the recess 38, the surface of the O-ring 36 may be in a state where grease is applied. The grease 44 may lubricate the sliding portion between the O-ring 36 and the sleeve 34. As a result, the sliding movement of the O-ring and the sleeve 34 may be made smooth. For purposes of clarity, the coating 46 is omitted in FIG. 12.

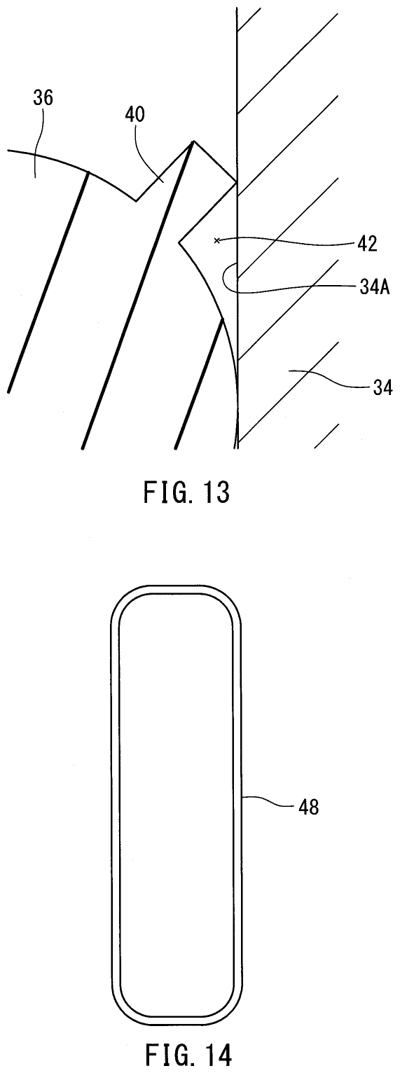

As shown in FIG. 13, due to the arrangement of the projection 40, a space may be defined by the projection 40, the outer peripheral surface of the O-ring 36, and the cylindrical inner peripheral surface 34A of the sleeve 34. This space may define a second grease reservoir 42. The second grease reservoir 42 may partly be defined by the inclined projection 40. The volume of the second grease reservoir 42 may be set to be more than the predetermined volume sufficient to effectively supply grease to the sliding contact surface. The position of the second grease reservoir 42 may be adjacent to the sliding contact area between the O-ring 36 and the sleeve 34. Thus, the grease 44 may be effectively supplied from the second grease reservoir 42 to the sliding contact surface to lubricate it.

The effects of the present embodiment are as follows. First, the effects of the coating 46 will be described. According to the present embodiment, as shown in FIGS. 5-8, the coating 46 may be applied to at least one of the outer peripheral surface of the O-ring 36 and the cylindrical inner peripheral surface 34A of the sleeve 34. The application of the coating 46 may reduce the sliding resistance at the area where the O-ring 36 contacts and slides relative to the sleeve 34. Thereby, a twisting phenomenon of the O-ring 36 at every position on the circumference during sliding may be suppressed and/or prevented. As a result, breakage and/or deformation of the O-ring 36 may be suppressed and/or prevented, thereby maintaining the sealing function of the O-ring 36.

Next, the effects of the projection 40 will be described. According to the present embodiment, the projection 40 may be formed on the outer peripheral surface of the O-ring 36 and oriented at an incline. The projection 40 may contact the cylindrical inner peripheral surface 34A of the sleeve 34 during sliding movement. Therefore, the twisting phenomenon of the O-ring 36 in the recess 38 may be suppressed. Accordingly, deformation of the O-ring 36 may be suppressed and/or prevented. As a result, the state of the grease reservoir formed in the recess 38, where the O-ring 36 fits, may be properly maintained. Further, grease may be smoothly supplied from the grease reservoir to the sliding area of the O-ring 36, and lubrication may be performed appropriately.

According to the present embodiment, the second grease reservoir 42 may be formed by the projection 40. The second grease reservoir 42 may be adjacent to the sliding contact area between the O-ring 36 and the sleeve 34. Therefore, grease may also be supplied from the second grease reservoir 42 to the O-ring 36.

The present disclosure is not limited to the embodiments described above, and various changes are possible.

For example, an elastic seal is used as the O-ring 36 in the above embodiment. However, other elastic sealing materials may be applied as the O-ring. For example, as shown in FIG. 14, in addition to the O-ring 36, a packing 48 having a circular cross-section may be applied.

Although the O-ring arrangement is applied to the purge pump 10 in the above embodiment, it may be applied to various other devices. In other words, the O-ring arrangement of the present disclosure may be widely applied to any device that has a slidingly fitted part and in which the O-ring 36 is arranged. For example, it may be applied to a valve that moves in the axial direction.

In the present embodiment, the projection 40 formed on the O-ring 36 may be formed using the parting line PL, which is formed when molding the O-ring 36. However, the projection 40 may be formed separately. For example, it may be formed by a wire.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved elastic seal arrangement in a slidingly fitted part, and/or methods of making and using the same.

What is claimed is:

1. An elastic seal arrangement for a slidingly fitted part, the elastic seal arrangement comprising:
a first sliding member having a sliding surface;
a second sliding member having a sliding surface in sliding contact with the sliding surface of the first sliding member;
a recess formed in the sliding surface of the first sliding member or the second sliding member; and
an elastic seal disposed in the recess and compressed between the first sliding member and the second sliding member to seal between the first sliding member and the second sliding member, wherein:
a coating configured to reduce sliding resistance is disposed on at least one of:
a sliding contact surface of the elastic seal; and
a sliding contact surface of the first sliding member or the second sliding member is in sliding contact with the elastic seal.

2. The elastic seal arrangement of claim 1, wherein:
the first sliding member is a cylinder-side member having a cylindrical shape;
the second sliding member is a shaft-side member having a shaft-shape and slidingly fitted in the cylinder-side member;
the cylinder-side member and the shaft-side member are configured move relative to each other in an axial direction;
the elastic seal is an annular O-ring; and
the coating is disposed on the sliding contact surface of the O-ring.

3. The elastic seal arrangement of claim 2, wherein:
a projection is formed on an outer peripheral surface of the O-ring;
the projection extends in a radial direction toward the sliding contact surface of the first sliding member or the second sliding member that is in sliding contact with the O-ring; and
the projection is disposed in an area where the coating is applied to the O-ring and outside the sliding contact surface of the first sliding member or the second sliding member with which the O-ring is in sliding contact.

4. The elastic seal arrangement of claim 3, wherein:
the projection is extends circumferentially about the entire circumference of the O-ring; and
a length of the projection is greater than a thickness of the coating on the O-ring.

5. The elastic seal arrangement of claim 4, wherein the projection contacts with the sliding surface of the first sliding member or the second sliding member that is in sliding contact with the O-ring.

6. The elastic seal arrangement of claim 3, wherein:
a grease reservoir is defined by the projection, the outer peripheral surface of the O-ring, and a cylindrical surface of the first sliding member or the second sliding member that is in sliding contact with the O-ring;
an inclination angle of the projection is based on a predetermined volume of the grease reservoir.
